(19) United States
(12) Patent Application Publication
(10) Pub. No.: US 2010/0060663 A1
(43) Pub. Date: Mar. 11, 2010

(54) IMAGE DISPLAY DEVICE AND METHOD OF DISPLAYING IMAGE

(76) Inventor: Jun Fujimoto, Tokyo (JP)

Correspondence Address: NDQ&M WATCHSTONE LLP, 1300 EYE STREET, NW, SUITE 1000 WEST TOWER, WASHINGTON, DC, 20005, US

(21) Appl. No.: 12/589,518

(22) Filed: Sep. 10, 2008

(51) Int. Cl. G09G 5/00

(52) U.S. Cl. 345/629; 345/672

(57) ABSTRACT

An image display device of the present invention comprises: a transmitter; a display controller; and a display including scanning lines allocated with line numbers; wherein the transmitter executes (A) outputting of an image signal added with a line number, the display controller executes: (a) displaying of an image to a line on the display, the line being corresponding to the line number added to the received image signal; and (b) holding of the displaying of the displayed image until receiving a new image signal, the transmitter executes (B) outputting of only the image signal added with the line number corresponding to the line having the image to be changed thereon, and the display controller executes (c) updating of only the image on the line corresponding to the line number added to the received image signal, when receiving the new image signal, so as to display the updated image.

### BACKGROUND OF THE INVENTION

1. Field of the Invention

The present invention relates to an image display and a method of displaying an image.

2. Discussion of the Background

A conventional liquid crystal display device, such as one disclosed in U.S. Pat. No. 6,417,898, includes: an element substrate including pixel electrodes arranged in a matrix form and each provided with a switching element; a counter substrate including a color filter and the like formed thereon, and a liquid crystal filling a gap between these two substrates. In such a liquid crystal display device, when a scanning line signal is applied to the switching element through the scanning line, the switching element come into a conduction state. When an image signal is applied to the pixel electrode through a data line in this conduction state, a predetermined amount of charge is accumulated in a liquid crystal layer. Even when the switching element is turned off after the accumulation of the charge, the accumulation of the charge would be held due to the capacity of the liquid crystal layer with a sufficiently high resistance of the crystal liquid layer. As thus described, when each switching element is driven so that the amount of charge to be accumulated is controlled, the orientational state of the liquid crystal varies in each pixel, and consequently, predetermined information can be displayed.

In such a conventional image display device, each scanning line is sequentially selected by a scanning line driving circuit. During a period when each scanning line is selected, an image signal (an image signal indicative of an image to be displayed to each scanning line) is sequentially supplied to each data line by a data line driving circuit. Thereby, an image is displayed to each scanning line, and a single image is displayed as a whole to the image display device.

Further, the conventional image display device has a standardized liquid crystal display. For example, in VGA (Video Graphics Array) or XGA (eXtended Graphics Array), an aspect ratio is 4:3. In HD-TV1 (High Definition TV1), an aspect ratio is 16:9. Hence there has been a problem that, when an image having a nonstandard aspect ratio is intended to be displayed, a part of the image may not be displayed or a screen may have a portion with no image displayed therein.

The present invention was made in view of the foregoing problem, and an object thereof is to provide an image display device and an image displaying method, which are capable of neatly displaying a non-standard image.

### SUMMARY OF THE INVENTION

A first aspect of the present invention provides an image display device having the following configuration.

Namely, the image display device comprises: a transmitter for outputting an image signal; a display controller; and a display including scanning lines each allocated with a line number. The transmitter executes processing of (A) outputting an image signal added with a line number. The display controller executes the processing of: (a) displaying an image based on the image signal received from the transmitter, to a line on the display, the line being corresponding to the line number added to the received image signal; and (b) holding the displaying of the image displayed in the processing (a) until a new image signal is received. The transmitter further executes processing of (B) outputting only the image signal added with the line number corresponding to the line having the image to be changed thereon. The display controller further executes processing of (c) updating, in the case of receiving the new image signal, only the image on the line corresponding to the line number added to the received image signal, to an image based on the received image signal so as to display the updated image.

According to the above image display device, the transmitter outputs an image signal added with a line number (processing (A)). The display controller displays an image, based on the image signal received from the transmitter, to a line (a scanning line) on the display corresponding to the line number added to the received image signal (processing (a)). The display controller then holds the displaying of the image displayed in the processing (a) until a new image signal is received (processing (b)). Thereafter, the transmitter outputs only an image signal added with a line number corresponding to the line having the image to be changed thereon (processing (B)). When receiving a new image signal, the display controller updates only the image on the line corresponding to the line number added to the received image signal, to an image based on the received image signal so as to display the updated image (processing (c)).

As thus described, according to the above-mentioned image display device, when the image is to be changed, only an image signal corresponding to the line which displays the image to be changed is transmitted from the transmitter. Therefore, when a non-standard moving image is to be displayed, for example, the transmitter may transmit only the image signals corresponding to the lines for displaying the moving image. As for a portion where the moving image is not to be displayed, the transmitter may transmit image signals for a still image thereto once, so that the still image is held. Consequently, it is possible to display the moving image and the still image in combination to a single display while reducing power consumption. Further, since the moving image and the still image can be displayed in combination, in the case where a non-standard moving image is displayed, it is possible to display the still image or the like in the portion where the moving image is not displayed, so as to neatly display an image to the display as a whole.

A second aspect of the present invention provides an image display device having the following configuration.

Namely, the image display device comprises: a transmitter for outputting an image signal; a display controller; and a plurality of displays connected to the display controller and each allocated with a display number. The transmitter executes processing of (A) outputting an image signal added with a display number. The display controller executes the processing of: (a) displaying an image based on the received image signal, to the display corresponding to the display number added to the received image signal; and (b) holding the displaying of the image displayed in the processing (a) until a new image signal is received. The transmitter further executes processing of (B) outputting only the image signal added with the display number corresponding to the display having the image to be changed thereon. The display controller further executes processing of (c) updating, in the case of receiving the new image signal, only the image on the display corresponding to the display number added to the received image signal, to an image based on the received image signal so as to display the updated image.

According to the above-mentioned image display device, the transmitter outputs an image signal added with a display number (processing (A)). The display controller displays an image based on the image signal received from the transmitter, to a display corresponding to the display number added to the received image signal (processing (a)). The display controller then holds the displaying of the image displayed in the processing (a) until a new image signal is received (processing (b)). Thereafter, the transmitter outputs only an image signal added with the display number corresponding to the display having the image to be changed thereon (processing (B)). When receiving a new image signal, the display controller updates only the image on the display corresponding to the display number added to the received image signal, to an image based on the received image signal so as to display the updated image (processing (c)).

As thus described, according to the above-mentioned image display device, a plurality of displays are provided, and when the image is to be changed, only an image signal added with a display number corresponding to the display having the image to be changed thereon, is transmitted from the transmitter. Accordingly, for example, when a plurality of displays are disposed on an outer wall of a building structure, only the displaying on some of the displays can be changed.

Further, since an image signal is added with a display number, wiring from the transmitter to the display controller can be made by using a single line. This enables simplification of wiring in the case of displaying an image on a plurality of displays.

It is desirable that the image display device further has the following configuration.

The image signal includes a plurality of kinds of locating data for specifying a display position of the image on the display. The transmitter further executes processing of (C) outputting a single display-position-specifying signal after transmitting the image signal. The display controller further executes processing of (d) displaying, in the case of receiving the display-position-specifying signal, the image in a position corresponding to the received display-position-specifying signal, with reference to the locating data.

According to the above-mentioned gaming machine, the image signal includes a plurality of kinds of locating data for specifying a display position of the image on the display. Upon receipt of a display-position-specifying signal, the display controller displays the image in a position corresponding to the received display-position-specifying signal, with reference to the locating data. Therefore, when only a display position of the image already on the display is to be changed, it is not necessary to re-output an image signal including image data, but it is only necessary to output a display-position-specifying signal, so that a load of data communication can be reduced.

The first aspect of the present invention further provides a method of displaying an image, which has the following configuration.

Namely, the method of displaying an image comprises steps of: (A) a transmitter outputting an image signal added with a line number; (a) a display controller displaying an image based on the image signal received from the transmitter, to a line on the display, the line being corresponding to the line number added to the received image signal; (b) the display controller holding the displaying of the image displayed in the step (a) until a new image signal is received; (B) the transmitter outputting only the image signal added with the line number corresponding to the line having the image to be changed thereon; and (c) the display controller updating, in the case of receiving the new image signal, only the image on the line corresponding to the line number added to the received image signal to the image based on the received image signal so as to display the updated image.

According to the above method of displaying an image, the transmitter outputs an image signal added with a line number (processing (A)). The display controller displays an image, based on the image signal received from the transmitter, to a line (a scanning line) on the display corresponding to the line number added to the received image signal (processing (a)). The display controller then holds the displaying of the image displayed in the processing (a) until a new image signal is received (processing (b)). Thereafter, the transmitter outputs only an image signal added with a line number corresponding to the line having the image to be changed (processing (B)). When receiving a new image signal, the display controller updates only the image on the line corresponding to the line number added to the received image signal, to an image based on the received image signal so as to display the updated image (processing (c)).

As thus described, according to the above-mentioned image display device, when the image is to be changed, only an image signal corresponding to the line which displays the image to be changed is transmitted from the transmitter. Therefore, when a non-standard moving image is to be displayed, for example, the transmitter may transmit only the image signals corresponding to the lines for displaying the moving image. As for a portion where the moving image is not to be displayed, the transmitter may transmit image signals for a still image thereto once, so that the still image is held. Consequently, it is possible to display the moving image and the still image in combination to a single display while reducing power consumption. Further, since the moving image and the still image can be displayed in combination, in the case where a non-standard moving image is displayed, it is possible to display the still image or the like in the portion where the moving image is not displayed, so as to neatly display an image to the display as a whole.

The second aspect of the present invention provides a method of displaying an image, which has the following configuration.

Namely, the method of displaying an image comprises steps of: (A) a transmitter outputting an image signal added with a display number; (a) a display controller displaying an image based on the received image signal, to a display corresponding to the display number added to the received image signal, out of a plurality of displays; (b) the display controller holding the displaying of the image displayed in the step (a) until a new image signal is received; (B) the transmitter outputting only the image signal added with a display number corresponding to the display having the image to be changed thereon; and (c) the display controller updating, in the case of receiving the new image signal, only the image on the display corresponding to the display number added to the received image signal, to an image based on the received image signal so as to display the updated image.

According to the above-mentioned method of displaying an image, when the images displayed on some displays out of the plurality of displays are to be changed, only image signals added with display numbers corresponding to the displays having the image to be changed thereon, are transmitted from the transmitter. Accordingly, for example, when a plurality of displays are disposed on an outer wall of a building structure, only the displaying on some of the displays can be changed.

Further, since an image signal is added with a display number, wiring from the transmitter to the display controller can be made by using a single line. This enables simplification of wiring in the case of displaying an image on a plurality of displays.

It is desirable that the method of displaying an image further has the following configuration.

Namely, according to the method of displaying an image, the image signal includes a plurality of kinds of locating data for specifying a display position of the image on the display. Further, the above-mentioned method of displaying an image comprises steps of: (C) the transmitter outputting a single display-position-specifying signal after transmitting the image signal; and (d) the display controller displaying, in the case of receiving the display-position-specifying signal, the image in a position corresponding to the received display-position-specifying signal, with reference to the locating data.

According to the above-mentioned method of displaying an image, the image signal includes a plurality of kinds of locating data for specifying a display position of the image on the display. Upon receipt of a display-position-specifying signal, the display controller displays the image in a position corresponding to the received display-position-specifying signal, with reference to the locating data. Therefore, when only a display position of the image already on the display is to be changed, it is not necessary to re-output an image signal including image data, but it is only necessary to output a display-position-specifying signal, so that a load of data communication can be reduced.

### BRIEF DESCRIPTIONS OF THE DRAWINGS

FIG. 1 is a flowchart showing image display processing, which is executed in a display controller provided in an image display device according to one embodiment of a first aspect of the present invention.

FIG. 2 is a block diagram showing an entire configuration of the image display device according to the embodiment of the first aspect of the present invention.

FIG. 3 is a block diagram showing an internal configuration of the display controller shown in FIG. 2.

FIG. 4 is an explanatory view of a configuration of an image signal according to the embodiment of the first aspect of the present invention.

FIG. 5 is an explanatory view of an image storage region provided in a RAM.

FIG. 6 is an exemplary view of an image displayed on a display.

FIG. 7 is an exemplary view of an image displayed on the display.

FIG. 8 is a block diagram showing an entire configuration of an image display device according to an embodiment of a second aspect of the present invention.

FIG. 9 is a block diagram showing an internal configuration of a display controller shown in FIG. 8.

FIG. 10 is an explanatory view of a configuration of an image signal according to the embodiment of the second aspect of the present invention.

FIG. 11 is an explanatory view of locating data.

FIG. 12 is an explanatory view of an image storage region provided in a RAM according to the embodiment of the second aspect of the present invention.

FIG. 13 is a flowchart showing image display processing, which is executed in the display controller provided in the image display device according to the embodiment of the second aspect of the present invention.

FIG. 14 is a perspective view schematically showing a usage state of the image display device.

FIG. 15 is a perspective view schematically showing a usage state of the image display device.

FIG. 16 is a perspective view schematically showing a usage state of the image display device.

### DESCRIPTION OF THE EMBODIMENTS

The present invention includes a first aspect of the present invention according to an image display device provided with a transmitter, a display controller and a single display. Further, the present invention includes a second aspect of the present invention according to an image display device provided with a transmitter, a display controller and a plurality of displays. In the following, first, an embodiment according to the first aspect of the present invention is described.

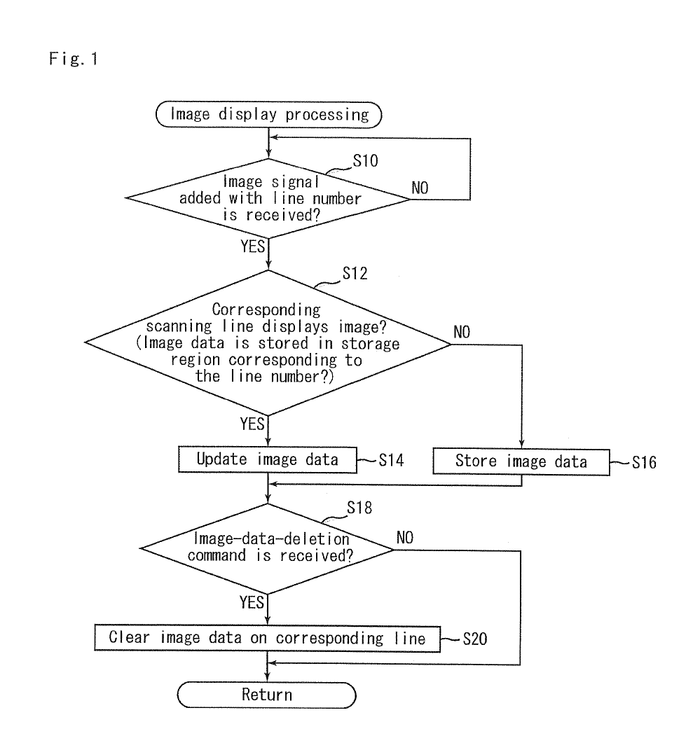

FIG. 1 is a flowchart showing image display processing which is executed in a display controller provided in an image display device according to an embodiment of the first aspect of the present invention.

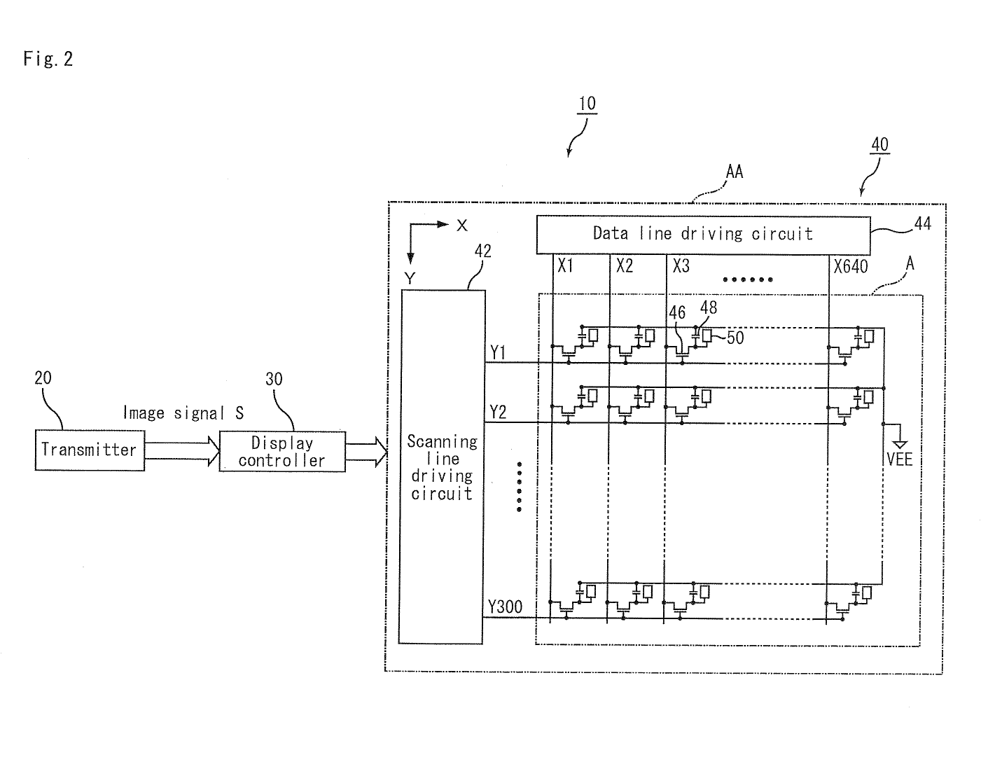

An image display device 10 includes a transmitter 20 (see FIG. 2) which outputs an image signal S. In accordance with an input made by a manager or in accordance with a predetermined program, an image signal S added with a line number LN is transmitted from the transmitter 20 to a display controller 30 (see FIG. 2). It is to be noted that the line number LN is associated with a scanning line Y (see FIG. 2) on a display 40. Namely, on the display 40 (see FIG. 2), the line number is allocated to each scanning line Y.

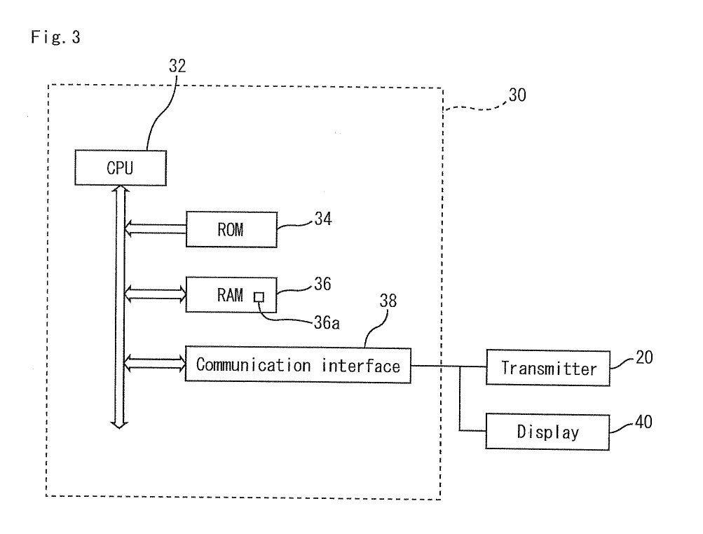

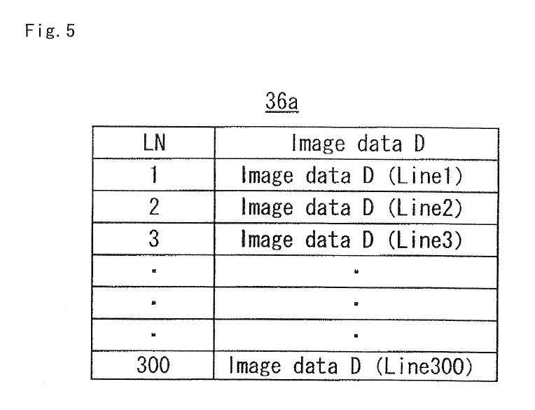

In step S10 of FIG. 1, first, a CPU 32 (see FIG. 3) provided in the display controller 30 waits until receiving the image signal S added with the line number LN (step S10: NO). Upon receipt of the image signal S added with the line number LN, the CPU 32 determines whether or not an image has already been displayed to the scanning line Y (step S12). In this processing, the CPU 32 determines whether or not image data D has been stored in a region associated with the scanning line Y (region corresponding to the line number LN) in an image storage region 36a (see FIG. 5) in a RAM 36 (see FIG. 3) provided in the display controller 30.

When determining in step S12 that an image has already been displayed to the scanning line Y, the CPU 32 clears the image data D stored in the region corresponding to the scanning line Y, and newly stores image data D based upon the image signal S received in step S10 into the region (step S14).

When determining in step S12 that an image has not been displayed to the scanning line Y, the CPU 32 stores the image data D based upon the image signal S received in step S10 into the region corresponding to the scanning line Y in the RAM 36 (step S16). It is to be noted that the image data D stored into the RAM 36 is held as it is unless updated or cleared.

After the processing of step S14 or step S16, the CPU 32 determines whether or not to have received an image-data-deletion command from the transmitter 20 (step S18). The image-data-deletion command is a command outputted from the transmitter 20 in accordance with an input made by the manager or in accordance with a predetermined program, and includes the line number DN as an object for deleting the image data D. When determining not to have received the image-data-deletion command from the transmitter 20, the CPU 32 completes the present subroutine. On the other hand, when determining to have received the image-data-deletion command from the transmitter 20, the CPU 32 clears the image data D of the line number LN included in the image-data-deletion command, out of the image data D stored in the image storage region of the RAM 36, and completes the present subroutine.

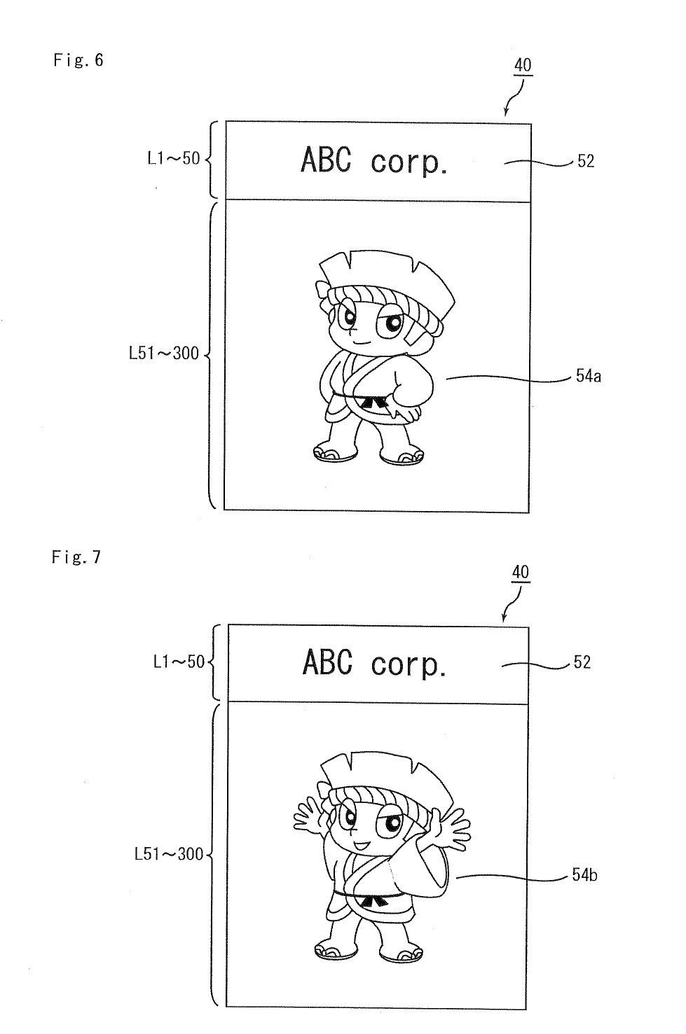

For example, a case is described where in step S14, the image data D for an image 52 (see FIG. 6) has already been stored in a region corresponding to line numbers LN 1 to 50 and the image data D for an image 54a (see FIG. 6) has already been stored in a region corresponding to line numbers LN 51 to 300, in the image storage region 36a. In this case, when an image signal S corresponding to the region corresponding to the line numbers LN 51 to 300 is newly received, the image data D stored in the region corresponding to the line numbers LN 1 to 50 in the image storage region 36a is held as it is. As a result, the displaying of the image 52 is held as it is. On the other hand, the image data D stored in the region corresponding to the line numbers LN 51 to 300 is updated to new image data D. As a result, for example, an image 54b (see FIG. 7) is displayed.

According to the image display device 10 and the method of displaying an image according to the present embodiment, when the image is to be changed, only the image signal S corresponding to the line (scanning line) which displays the image to be changed is transmitted from the transmitter 20. Therefore, when a non-standard moving image (e.g. a moving image changing from the image 92A to the image 92b) is to be displayed, the transmitter 20 may transmit only the image signals S corresponding to the lines for displaying the moving image. As for a portion where the moving image is not to be displayed, the transmitter 20 may transmit image signals S for a still image thereto once, so that the still image is held. Consequently, it is possible to display the moving image and the still image in combination to a single display 40 while reducing power consumption. Further, since the moving image and the still image can be displayed in combination, in the case where a non-standard moving image is displayed, it is possible to display the still image or the like in the portion where the moving image is not displayed, so as to neatly display an image to the display as a whole.

FIG. 2 is a block diagram showing an entire configuration of the image display device according to the embodiment of the first aspect of the present invention.

FIG. 3 is a block diagram showing an internal configuration of the display controller shown in FIG. 2.

The image display device 10 includes the transmitter 20 for outputting the image signal S, the display controller 30 and the display 40.

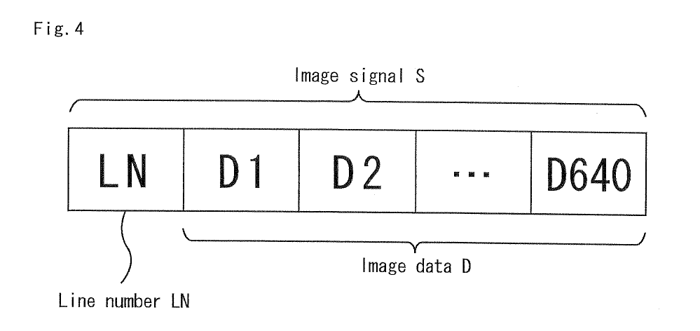

The transmitter 20 is connected to a management device, which is not shown. In accordance with an input made by a manager into the management device or in accordance with a predetermined program executed in the management device, the image signal S added with the line number LN is outputted from the transmitter 20 to the display controller 30. It is to be noted that the configuration of the image signal S is described later by using FIG. 4.

The display controller 30 includes a CPU 32, a ROM 34, the RAM 36, and a communication interface 38.

The ROM 34 stores a variety of programs for performing display control on the display 40, data tables, and the like. The RAM 36 is a memory for temporarily storing a variety of data calculated in the CPU 32. In particular, the RAM 36 is provided with the image storage region 36a for storing the image data D included in the image signal S that is received from the transmitter 20. The communication interface 38 is for receiving the image signal S from the transmitter 20 and for outputting a signal related to the display control on the display 40.

In the present embodiment, the display 40 is a liquid crystal display, and has a liquid crystal panel AA. An image display region A, a scanning line driving circuit 42 and a data line driving circuit 44 are formed on an element substrate of the liquid crystal panel AA.

In the image display region A, “m” number of scanning lines Y are formed in an array parallel to the X direction, while “n” number of data lines X are formed in an array parallel to the Y direction. In the present embodiment, the case of m=300 and n=640 is described. As shown in FIG. 2, in the vicinity of an intersection of the scanning line Y and the data line X, a gate of a TFT 46 is connected to the scanning line Y, a source of the TFT 46 is connected to the data line X, and a drain of the TFT 46 is connected to a pixel electrode 50. Each pixel includes the pixel electrode 50, a counter electrode formed on a counter substrate, and a liquid crystal sandwiched between these two electrodes. As a result, each pixel is disposed at each intersection of the scanning line Y and the data line X, so that the pixels are arrayed in a matrix form. Signals are respectively supplied to the scanning line Y and the data line X by the scanning line driving circuit 42 and the data line driving circuit 44, so that a voltage is applied to each pixel.

It is possible to separately supply a signal to each scanning line Y connected with the gate of the TFT 46. A scanning line signal is supplied to the scanning line Y corresponding to the line number LN, which is added to the image signal S received from the transmitter 20, and the TFT 46 connected to the scanning line is turned on. Further, when signals are respectively supplied to data lines X1, X2 . . . X640 at predetermined timings in accordance with the image data D, voltages are applied to the corresponding pixels, and the state is held until a new voltage is applied or the voltage application is released.

It is to be noted that, for the purpose of preventing the held voltage from leaking, an accumulation capacity 48 is added in parallel with the capacity of the liquid crystal formed between the pixel electrode 50 and the counter electrode.

Here, the configuration of the image signal S according to the present embodiment is described.

FIG. 4 is an explanatory view of the configuration of the image signal.

The image signal S comprises the line number LN and the image data D.

The line number LN indicates the scanning line Y on the display 40 to which the image data D subsequent to the line number LN corresponds. For example, when the line number LN is “1”, the image data D is an image signal corresponding to a scanning line Y1, and when the line number LN is “2”, the image data D is an image signal corresponding to a scanning line Y2. Further, the image data D1, D2 . . . D640 constituting the image data D correspond to the data lines X1, X2 . . . X640 shown in FIG. 2.

FIG. 5 is an explanatory view of the image storage region 36a provided in the RAM 36.

As shown in FIG. 5, the image storage region 36a can store the image data D with respect to each line number LN.

FIGS. 6 and 7 are exemplary views each showing an image displayed on the display 40.

FIG. 6 is an image displayed in the case of receiving, from the transmitter 20, 300 specific image signals S added with line numbers LN 1, 2, 3 . . . 300.

In accordance with the image data D added with the line numbers LN 1 to 50, an image 52 of “ABC Corp.” is displayed in a position corresponding to the line numbers LN 1 to 50 on the display 40. Further, in accordance with the image data D added with the line numbers LN 51 to 300, a character image 54a is displayed in a position corresponding to the line numbers LN 51 to 300 on the display 40.

FIG. 7 is an image displayed in the case of receiving, from the transmitter 20, 250 specific image signals S added with the line numbers LN 51, 52, 53 . . . 300 after the displaying of the image shown in FIG. 6.

In the image shown in FIG. 7, since the image signals S added with the line numbers LN 1 to 50 have not been received, the image of “ABC Corp.” displayed in the position corresponding to the line numbers LN 1 to 50 remains unchanged from the state in FIG. 6, and its displaying is held as it is. On the other hand, since 250 specific image signals S added with the line numbers LN 51, 52, 53 . . . 300 have been received, the image data D of the line numbers LN 51 to 300 is updated to a new image data D (see step S14 in FIG. 1). As a result, in accordance with the new image data D added with the line numbers LN 51 to 300, the character image 54b is displayed in the position corresponding to the line numbers LN 51 to 300 on the display 40.

As thus described, according to the image display device 10 and the image displaying method according to the present embodiment, when the image is to be changed, only the image signal S corresponding to the line which displays the image to be changed is transmitted from the transmitter 20. Therefore, when a non-standard moving image (in the present embodiment, a moving image changing from the image 92A to the image 92b) is to be displayed, the transmitter 20 may transmit only the image signals S corresponding to the lines for displaying the moving image. As for a portion where the moving image is not to be displayed, the transmitter 20 may transmit image signals S for a still image (in the present embodiment, the line number 1 to 50) thereto once, so that the still image is held. Consequently, it is possible to display the moving image and the still image in combination to a single display 40 while reducing power consumption. Further, since the moving image and the still image can be displayed in combination, in the case where a non-standard moving image is displayed, it is possible to display the still image or the like in the portion where the moving image is not displayed, so as to neatly display an image to the display as a whole.

Next, an embodiment according to the second aspect of the present invention is described.

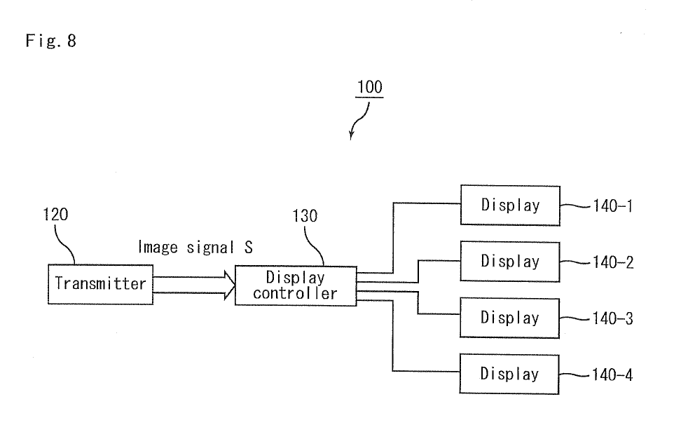

FIG. 8 is a block diagram showing an entire configuration of an image display device according to an embodiment of the second aspect of the present invention.

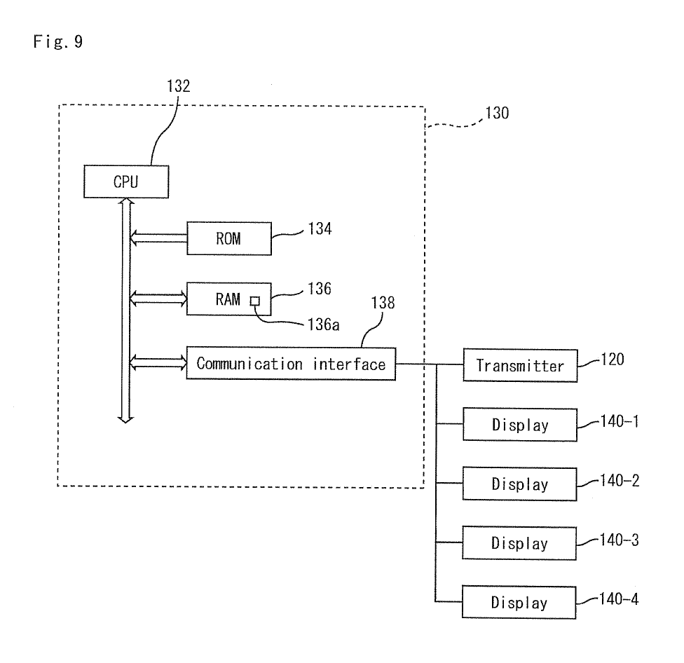

FIG. 9 is a block diagram showing an internal configuration of a display controller 130 shown in FIG. 8.

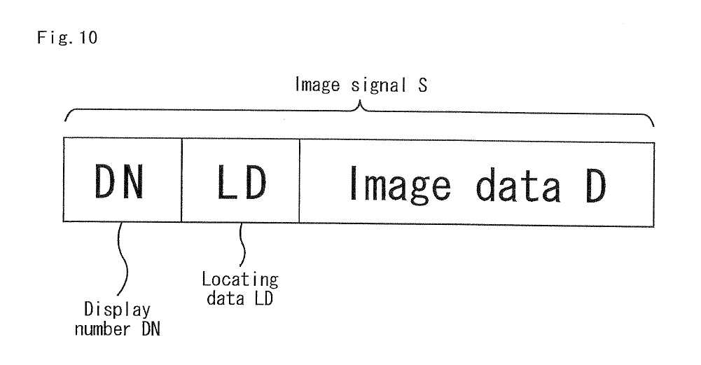

As shown in FIG. 8, an image display device 100 is provided with a transmitter 120 for outputting an image signal S, the display controller 130, and a plurality of (four in the present embodiment) displays 140 (140-1, 140-2, 140-3, 140-4). The transmitter 120 is connected with a management device, which is not shown, and in accordance with an input made by a manager into the management device or in accordance with a predetermined program executed in the management device, the image signal S is outputted from the transmitter 120 to the display controller 130. The image signal S is added with a display number DN and locating data LD. It is to be noted that the configuration of the image signal S is described later by using FIG. 10.

As shown in FIG. 9, the display controller 130 includes a CPU 132, a ROM 134, a RAM 136, and a communication interface 138.

The ROM 134 stores a variety of programs for performing display control on four displays 140, data tables, and the like. The RAM 136 is a memory for temporarily storing a variety of data calculated in the CPU 132. In particular, the RAM 136 is provided with the image storage region 136a for storing the image data D included in the image signal S that is received from the transmitter 20. The communication interface 138 is for receiving the image signal S from the transmitter 120 and for outputting a signal related to the display control on the displays 140.

Here, the configuration of the image signal S according to the present embodiment is described.

FIG. 10 is an explanatory view of the configuration of the image signal according to the embodiment of the second aspect of the present invention.

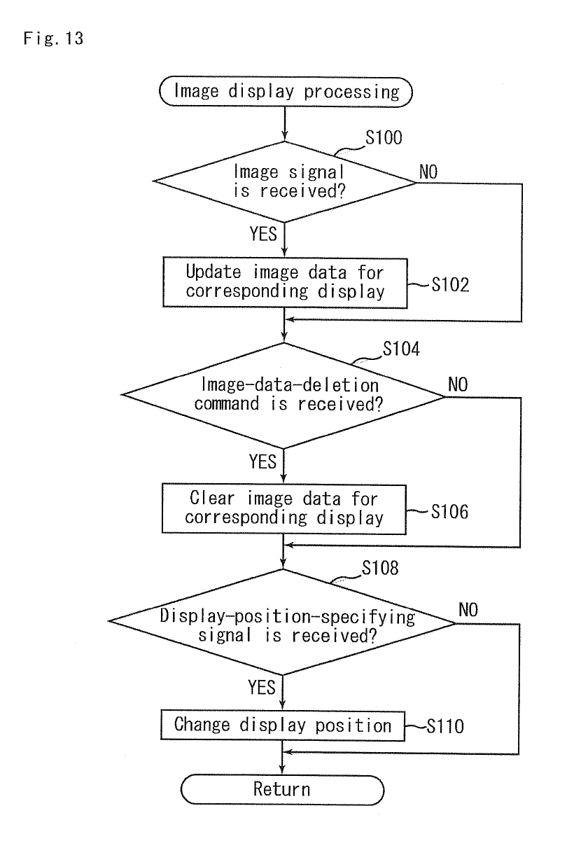

The image signal S comprises the display number DN, the locating data LD and the image data D. The display number DN indicates the display 140 out of the four displays 140, which the image data D subsequent to the display number DN is for. For example, the image data D includes an image data D corresponding to the display 140-1 when the display number DN is “1” (see FIG. 13), and the image signal includes an image data D corresponding to the display 140-2 when the display number DN is “2” (see FIG. 13).

It is to be noted that, in the present embodiment according to the second aspect of the present invention, a single image based upon a single image data D is displayed to a single display 140. That is, a single image data D is data for displaying a single image to any one display 140 out of the four displays 140.

The locating data LD is data for specifying the position on the display 140 in which an image is to be displayed at the time of displaying the image to the display 140.

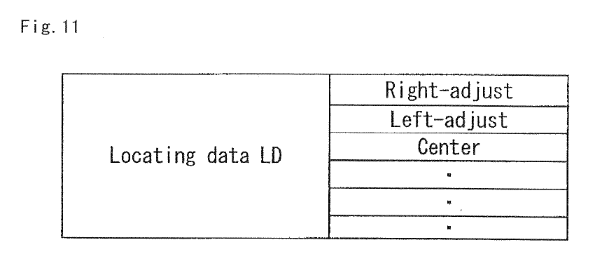

FIG. 11 is an explanatory view of locating data.

The locating data LD comprises a plurality of data for specifying display positions.

Examples of specification of a display position may include “Right-adjust”, “Left-adjust” and “Center”. Upon receiving a display-position-specifying signal after receipt of the image signal S, the CPU 132 displays the image in a position specified by the display-position-specifying signal, by the use of data (locating data LD) in accordance with a received display specification command.

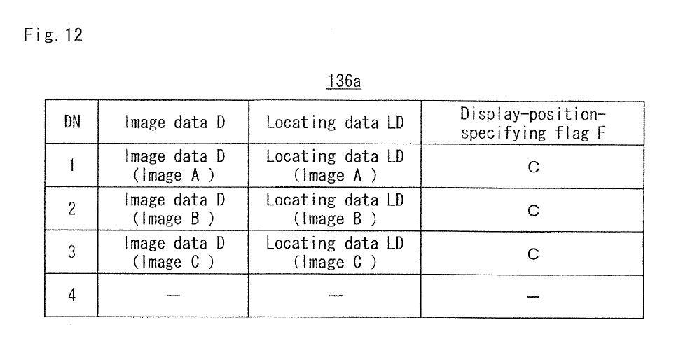

FIG. 12 is an explanatory view of the image storage region 136a provided in the RAM 136 (see FIG. 9).

As shown in FIG. 12, in the image storage region 136a, the image data D can be stored with respect to each display number DN. It is to be noted that the locating data LD can be additionally stored in the image storage region 136a.

In FIG. 12, image data D related to an image A is stored in a region corresponding to a display number DN 1, image data D related to an image B is stored in a region corresponding to a display number DN 2, and image data D related to an image C is stored in a region corresponding to a display number DN 3. Further, image data D is not stored in a region corresponding to a display number DN 4.

It is to be noted that a display-position-specifying flag F can be additionally stored in the image storage region 136a. The display-position-specifying flag F is a flag indicative of the receipt of a command when the display-position-specifying signal is received from the transmitter 120. In the case where the display-position-specifying signal has not been received, “C (center)” is stored as the display-position-specifying flag F. In the case where the display-position-specifying signal has been received, “L (left)”, “R (right)” or the like is stored in accordance with the command.

FIG. 13 is a flowchart showing image display processing, which is executed in the display controller provided in the image display device according to the embodiment of the second aspect of the present invention.

The image display device 100 is provided with the transmitter 120 for outputting the image signal S, and in accordance with an input made by the manager or a predetermined program, the image signal S added with the display number DN is transmitted from the transmitter 120 to the display controller 130. It is to be noted that the display number DN is associated with any one of the four displays 140.

The CPU 132 provided in the display controller 130 first determines whether or not to have received the image signal S (step S100). When determining not to have received the image signal, the CPU 132 shifts the processing to step S104. On the other hand, when determining to have received the image signal, the CPU 132 stores the image data D in the corresponding region of the image storage region 136a, based upon the display number DN included in the image signal S (step S102). For example, when receiving the image signal S including the image data D that is related to the image A and being added with the display number DN1, the CPU 132 stores the image data D related to the image A in a region corresponding to the display number DN1 of the image storage region 136a. In a case where another image data D has already been stored, the CPU 132 clears this image data D for an effect image, and newly stores image data D based upon the received image signal S into the region. As a result of storing the image data D into the image storage region 136a, an image based upon the image data D is displayed to the display 140. It is to be noted that “Center” is set as an initial value of the display position of the image. Thereafter, the CPU 132 shifts the processing to step S104.

In step S104, the CPU 132 determines whether or not to have received the image-data-deletion command from the transmitter 120. When determining to have received the image-data-deletion command, the CPU 132 clears the image data D stored in the image storage region 136a, which is corresponding to the display number DN included in the image-data-deletion command (step S106).

When determining in step S104 not to have received the image-data-deletion command, or after the processing of step S106, the CPU 132 determines whether or not to have received a display-position-specifying signal from the transmitter 120 (step S108). When determining to have received the display-position-specifying signal, the CPU 132 updates a display-position-specifying flag F (see FIG. 12) of the display number DN that is included in the display-position-specifying signal (stop Slid). The CPU 132 then displays an image in a position based upon the updated display-position-specifying flag F. For example, when the display-position-specifying signal including the display number DN2 is a command indicative of the display position of “Left-adjust”, the image B displayed to the display 140 (display 140-2) that is corresponding to the display number DN2 is “left-adjusted” for display. In addition, left-adjusted display is conducted based upon the locating data LD.

When determining in step S108 not to have received the display-position-specifying signal, or after the processing of step S110, the CPU 132 completes the present subroutine.

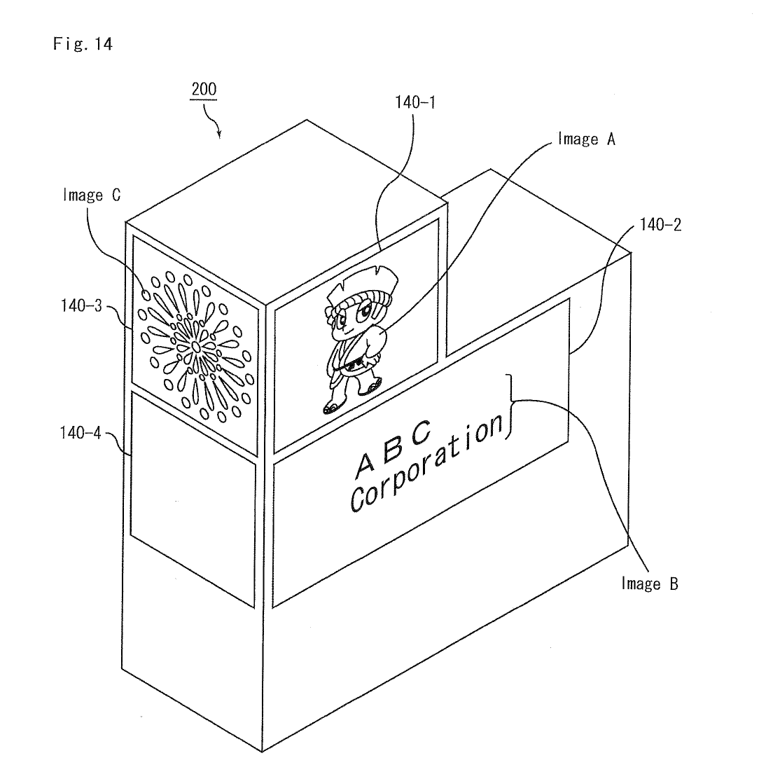

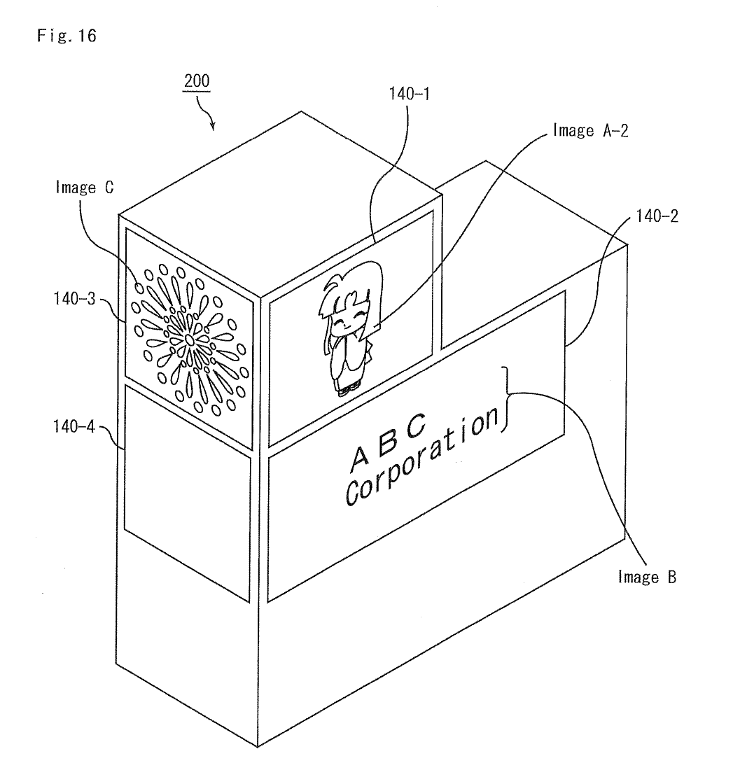

FIGS. 14 to 16 are perspective views each schematically showing a usage state of the image display device.

On the outer walls of a high-rise building 200, four displays 140 (displays 140-1, 140-2, 140-3 and 140-4) provided in the image display device 10 are installed.

FIG. 14 shows a condition where the image data D is stored in the image storage region 136a in the state shown in FIG. 12. The image A is displayed at the center of the display 140-1, the image B is displayed at the center of the display 140-2, and the image C is displayed at the center of the display 140-3. It is to be noted that no image is displayed on the display 140-4.

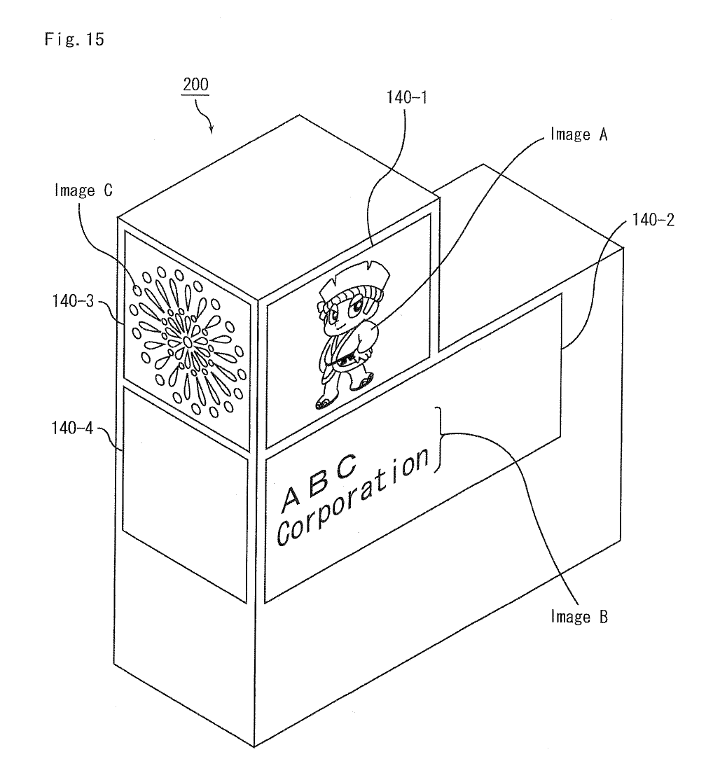

Then, when receiving the display-position-specifying signal showing the display number DN 2 and the display position of “Left Adjust”, the image B is displayed in a left-adjusted form to the display 140-2 corresponding to the display number DN2, as shown in FIG. 15.

Further, in the state shown in FIG. 14, when receiving new image data D (image data D related to an image A-2) including the display number DN 1, the image A-2 is displayed to the display 140-1 corresponding to the display number DN1, as shown in FIG. 17.

As thus described, according to the image display device 100 and the method of displaying an image according to the present embodiment, four displays 140 are provided, and when the image is to be changed, only the image signal S added with the display number DN corresponding to the display having the image to be changed thereon, is transmitted from the transmitter 120. Accordingly, for example, when four displays 140 are disposed on an outer wall of a high-rise building 200, only the displaying on some of the displays can be changed.

Further, since the image signal S is added with the display number DN, wiring from the transmitter 120 to the display controller 140 can be made by using a single line. This enables simplification of wiring in the case of displaying an image on four displays 140.

According to the image display device 100 and the method of displaying an image according to the present embodiment, the image signal S includes a plurality of kinds of locating data for specifying a display position of the image on the display 140. Upon receipt of a display-position-specifying signal, the display controller 130 displays the image in a position corresponding to the received display-position-specifying signal, with reference to the locating data. Therefore, when only a display position of the image already on the display 140 is to be changed, it is not necessary to re-output the image signal S including image data, but it is only necessary to output a display-position-specifying signal, so that a load of data communication can be reduced.

In the foregoing embodiment, the case of using a rectangular display was described. However, the display in the present invention is not limited to a rectangular display, but a circular, oval or polygonal display may be adopted. Further, in the present invention, a flexible display that is mountable on a curved surface may also be adopted.

It is to be noted that in the present invention, a display (e.g. L-shaped display) manufactured by using an offcut (a part to be a waste material) generated in the manufacturing process of another display may be used.

Although the embodiments of the present invention were described above, they were just illustrations of specific examples, and hence do not particularly restrict the present invention. A specific configuration of each step and the like is appropriately changeable in terms of design. Further, the effects described in the embodiments of the present invention are just recitations of the most suitable effects generated from the present invention. The effects of the present invention are thus not limited to those described in the embodiments of the present invention.

Further, the foregoing detailed descriptions centered the characteristic parts of the present invention in order to facilitate understanding of the present invention. The present invention is not limited to the embodiments in the foregoing specific descriptions but applicable to other embodiments with a variety of application ranges. Further, terms and phrases in the present specification were used not for restricting interpretation of the present invention but for precisely describing the present invention. It is considered easy for the skilled in the art to conceive other configurations, systems, methods and the like included in the concept of the present invention from the concept of the invention described in the specification. Therefore, it should be considered that recitations of the claims include uniform configurations in a range not departing from the range of technical principles of the present invention. Moreover, an object of the abstract is to enable a patent office, a general public institution, an engineer belonging to the technical field who is unfamiliar with patent, technical jargon or legal jargon, and the like, to smoothly determine technical contents and an essence of the present application with simple investigation. Accordingly, the abstract is not intended to restrict the scope of the invention which should be evaluated by recitations of the claims. Furthermore, for thorough understanding of an object of the present invention and an effect specific to the present invention, it is desired to make interpretation in full consideration of documents already disclosed and the like.

The foregoing detailed descriptions include processing executed on a computer or a computer network. Explanations and expressions above are described with the aim of being most efficiently understood by the skilled person in the art. In the specification, each step for use in deriving one result should be understood as the self-consistent processing. Further, in each step, transmission/reception, recording or the like of an electrical or magnetic signal is performed. While such a signal is expressed by using a bit, a value, a symbol, a letter, a term, a number or the like in processing of each step, it should be noted that those are used simply for the sake of convenience in description. While there are cases where processing in each step may be described using an expression in common with that of action of a human, processing described in the specification is essentially executed by a variety of devices. Further, another configuration requested for performing each step should become apparent from the above descriptions.

What is claimed as new and desired to be secured by Letters Patent of the United States is:

1. An image display device comprising:
a transmitter for outputting an image signal; a display controller; and a display including scanning lines each allocated with a line number,
wherein
said transmitter executes processing of
(A) outputting an image signal added with a line number,
said display controller executes the processing of:
(a) displaying an image based on the image signal received from said transmitter, to a line on said display, said line being corresponding to the line number added to the received image signal; and
(b) holding the displaying of the image displayed in said processing (a) until a new image signal is received,
said transmitter further executes processing of
(B) outputting only the image signal added with the line number corresponding to said line having the image to be changed thereon, and
said display controller further executes processing of
(c) updating, in the case of receiving the new image signal, only the image on said line corresponding to the line number added to the received image signal, to an image based on the received image signal so as to display the updated image.

2. An image display device comprising:
a transmitter for outputting an image signal; a display controller; and a plurality of displays connected to said display controller and each allocated with a display number,
wherein
said transmitter executes processing of
(A) outputting an image signal added with a display
number,
said display controller executes the processing of:
(a) displaying an image based on the received image signal, to said display corresponding to the display number added to the received image signal; and
(b) holding the displaying of the image displayed in said processing (a) until a new image signal is received,
said transmitter further executes processing of
(B) outputting only the image signal added with the display number corresponding to said display having the image to be changed thereon, and
said display controller further executes processing of
(c) updating, in the case of receiving the new image signal, only the image on said display corresponding to the display number added to the received image signal, to an image based on the received image signal so as to display the updated image.

3. The image display device according to claim 2,
wherein
said image signal includes a plurality of kinds of locating data for specifying a display position of the image on said display,
said transmitter further executes processing of
(C) outputting a single display-position-specifying signal after transmitting the image signal, and
said display controller further executes processing of
(d) displaying, in the case of receiving the display-position-specifying signal, the image in a position corresponding to the received display-position-specifying signal, with reference to the locating data.

4. A method of displaying an image, the method comprising steps of:
(A) a transmitter outputting an image signal added with a line number;
(a) a display controller displaying an image based on the image signal received from said transmitter, to a line on said display, said line being corresponding to the line number added to the received image signal;
(b) said display controller holding the displaying of the image displayed in said step (a) until a new image signal is received;
(B) said transmitter outputting only the image signal added with the line number corresponding to said line having the image to be changed thereon; and
(c) said display controller updating, in the case of receiving the new image signal, only the image on said line corresponding to the line number added to the received image signal to the image based on the received image signal so as to display the updated image.

5. A method of displaying an image, the method comprising steps of:
(A) a transmitter outputting an image signal added with a display number;
(a) a display controller displaying an image based on the received image signal, to a display corresponding to the display number added to the received image signal, out of a plurality of displays;
(b) said display controller holding the displaying of the image displayed in said step (a) until a new image signal is received;
(B) said transmitter outputting only the image signal added with a display number corresponding to said display having the image to be changed thereon; and
(c) said display controller updating, in the case of receiving the new image signal, only the image on said display corresponding to the display number added to the received image signal, to an image based on the received image signal so as to display the updated image.

6. The method of displaying an image according to claim 5,
using
said image signal including a plurality of kinds of locating data for specifying a display position of the image on said display, and
comprising steps of:
(C) said transmitter outputting a single display-position-specifying signal after transmitting the image signal; and
(d) said display controller displaying, in the case of receiving the display-position-specifying signal, the image in a position corresponding to the received display-position-specifying signal, with reference to the locating data.
